(19) United States
(12) Patent Application Publication
(10) Pub. No.: US 2026/0061439 A1
(43) Pub. Date: Mar. 5, 2026

(54) ECCENTRIC SWAYING WASHING NOZZLE

(71) Applicant: Ningbo Daye Garden Industry Co., Ltd, Yuyao (CN)

(72) Inventors: Xiaodong YE, Yuyao (CN); Fei GONG, Yuyao (CN); Qinbo LI, Yuyao (CN)

(73) Assignee: Ningbo Daye Garden Industry Co., Ltd, Yuyao (CN)

(21) Appl. No.: 18/944,443

(22) Filed: Nov. 12, 2024

(30) Foreign Application Priority Data
Sep. 4, 2024 (CN) 202422174676.4

(51) Int. Cl. B05B 3/04; B08B 3/02

(52) U.S. Cl. CPC B05B 3/043; B08B 3/02

(57) ABSTRACT

The present invention discloses an eccentric swaying washing nozzle, including a housing, a jet hole, a nozzle, a fixing ring, a water wheel, a fixing cover, and the like. A nozzle ball head is arranged on a front end of the nozzle, and a plurality of evenly distributed circumferential external positioning ribs are provided on an outer circumferential surface of the nozzle ball head. A nozzle hole is provided in the nozzle, and the front end of the nozzle hole extends through the nozzle ball head and is in communication with the jet hole to form water outflow. In this way, when water entering the housing drives the water wheel to rotate and drives a rear end of the nozzle to perform circumferential eccentric rotation, the nozzle ball head can be driven to synchronously perform circumferential eccentric swaying relative to the jet hole under the restriction of the plurality of external positioning ribs, so that the water outflow at the jet hole is also spraying in a circumferential eccentric swaying manner. Obviously, such an eccentric swaying structure is easier to assemble and can effectively prevent the nozzle ball head from getting stuck accidentally. In addition, a double-layer wear-resistant washer is arranged between blades of the water wheel and the adjacent fixing ring to prevent the water wheel from getting stuck and affecting rotation. These structural improvements can improve usage reliability of the washing nozzle and extend a service life.

### CROSS REFERENCE TO RELATED APPLICATION

This disclosure claims priority to Chinese Patent Application No. 202422174676.4 filed on Sep. 4, 2024, the disclosure of which is incorporated herein in reference in its entirety.

### TECHNICAL FIELD

The present invention relates to a washing nozzle, and in particular, to an eccentric swaying washing nozzle.

### BACKGROUND

At present, a washing nozzle is mainly applied to a water gun as a terminal water outflow component, of which a structure includes a housing and a jet hole at a front end of the housing. A nozzle, a fixing ring, a water wheel, and a fixing cover that are successively mounted from back to front are arranged in the housing. A front end of the nozzle is provided with a nozzle ball head, and a nozzle hole extending through the nozzle along an axis is provided in the nozzle. A front end of the nozzle hole extends through the nozzle ball head and is in communication with the jet hole to discharge water. In this way, when water entering the housing drives the water wheel to rotate, a rear end of the nozzle is driven to perform circumferential eccentric rotation, and then the nozzle ball head is driven to synchronously perform the circumferential eccentric rotation, so that the water outflow formed by the nozzle hole in communication with the jet hole is also spraying in a circumferential eccentric rotation manner. During the action, the eccentric rotation of the nozzle ball head constantly rubs the front end of the housing. Therefore, it is often necessary to arrange a wear-resistant sealing ring in the jet hole at the front end of the housing. This not only complicates the mounting structure, but also the wear-resistant sealing ring is easily displaced due to the continuous friction of the nozzle ball head and accidentally stuck in the nozzle ball head, thus affecting the normal use of the entire washing nozzle. In addition, as a rotating component in the housing, a wear-resistant washer needs to be arranged between a blade of the water wheel and the adjacent fixing ring to prevent wear. However, only one conventional wear-resistant washer is designed. When the water wheel is impacted by high-pressure water in an axial direction, the water wheel directly withstands the single wear-resistant washer and cannot convert an axial impact force into a rotating force of the water wheel. In other words, the single wear-resistant washer directly sticks to the water wheel and affects the rotation of the water wheel, which also affects the normal use of the washing nozzle.

### SUMMARY

A technical problem to be resolved by the present invention is to overcome the defects of the prior art and provide an eccentric swaying washing nozzle that can cause a nozzle ball head to perform circumferential eccentric swaying and simplify the assembly structure therein, and prevent a water wheel from being stuck during rotation.

The technical problem of the present invention is achieved through the following technical solutions.

An eccentric swaying washing nozzle is provided, including a housing and a jet hole at a front end of the housing. A nozzle, a fixing ring, a water wheel, and a fixing cover that are successively mounted from back to front are arranged in the housing. The fixing ring and the fixing cover are both fixed in the housing. The water wheel is rotatably mounted in the housing. A nozzle ball head is arranged at a front end of the nozzle. A plurality of evenly distributed circumferential external positioning ribs are arranged on an outer circumferential surface of the nozzle ball head. A nozzle hole extending through the nozzle along an axis is provided in the nozzle. A front end of the nozzle hole extends through the nozzle ball head and is in communication with the jet hole to form water outflow. Water entering the housing drives the water wheel to rotate and drives a rear end of the nozzle to perform circumferential eccentric rotation, and then drives the nozzle ball head to synchronously perform circumferential eccentric swaying relative to the jet hole under the restriction of the plurality of external positioning ribs, and the water outflow formed by the nozzle hole in communication with the jet hole is also spraying in a circumferential eccentric swaying manner.

Each of the external positioning ribs is a rectangular bump extending along an axial direction of the nozzle.

A curling edge that is turned up from a hole edge of the jet hole to a rear circumference is arranged in the jet hole, and the nozzle ball head is attached to an inner edge of the curling edge through a spherical surface to perform circumferential eccentric swaying.

The nozzle ball head performs a circumferential eccentric swaying relative to the jet hole, and drives the plurality of external positioning ribs to contact the curling edge to form a circumferential eccentric swaying stroke of the nozzle ball head.

A plurality of evenly distributed circumferential blades in a radial pattern are arranged on an outer circumferential surface of the water wheel, and a double-layer wear-resistant washer is arranged between front end surfaces of the plurality of blades and a rear end surface of the fixing ring.

A water wheel ball head is arranged on a front end of the water wheel, an axis of the water wheel ball head is eccentric with respect to a rotation axis of the water wheel, the water wheel ball head passes through a center hole of the fixing ring and is movably fitted in a rear end of the nozzle hole, and the water wheel rotates to drive the water wheel ball head to perform circumferential eccentric rotation in the rear end of the nozzle hole, thereby driving the rear end of the nozzle to synchronously perform the circumferential eccentric rotation.

A pressure relief hole extending through the fixing cover along the axis is provided in the fixing cover, and a water wheel hole extending through the water wheel along the axis is provided in the water wheel. A front end of the water wheel hole extends through the water wheel ball head. High-pressure water enters the housing, and a pressure of the high-pressure water is relieved by the pressure relief hole, the water wheel hole, the nozzle hole, and the jet hole that are in communication with each other in sequence.

A core shaft extending forward along the axis is arranged on a front end surface of the fixing cover, the water wheel is rotatably sleeved on the core shaft through a rear end of the water wheel hole, and the pressure relief hole is provided in the core shaft and runs through along the axis.

A rear water chamber is provided on the front end surface of the fixing cover, and a plurality of evenly distributed circumferential inclined water inflow holes with the pressure relief hole as a center are provided on the fixing cover. The plurality of inclined water inflow holes are inclined along a clockwise or counterclockwise direction and in communication with the rear water chamber. The plurality of blades of the water wheel are arranged in the rear water chamber. The water entering the housing enters the rear water chamber through the plurality of inclined water inflow holes and impacts the plurality of blades to drive the water wheel to rotate.

A front part of the fixing ring forms a front water chamber, and a plurality of evenly distributed circumferential inclined water outflow holes with an axis of the fixing ring as a center are provided on the fixing ring. The plurality of inclined water outflow holes are inclined along the clockwise or counterclockwise direction, each of the inclined water outflow holes is in communication with the rear water chamber and the front water chamber. A plurality of evenly distributed circumferential side water inflow holes are provided on an outer circumferential surface of the nozzle, and each of the side water inflow holes is in communication with the front water chamber and the nozzle hole.

Compared with the prior art, in the present invention, the nozzle ball head is arranged on the front end of the nozzle, and a plurality of evenly distributed circumferential external positioning ribs are provided on an outer circumferential surface of the nozzle ball head. A nozzle hole extending through the nozzle along the axis is provided in the nozzle, and the front end of the nozzle hole extends through the nozzle ball head and is in communication with the jet hole to form water outflow. In this way, when water entering the housing drives the water wheel to rotate and drives a rear end of the nozzle to perform circumferential eccentric rotation, the nozzle ball head can be driven to synchronously perform circumferential eccentric swaying relative to the jet hole under the restriction of the plurality of external positioning ribs, so that the water outflow formed by the nozzle hole in communication with the jet hole is also spraying in a circumferential eccentric swaying manner. Obviously, such a manner of using the plurality of evenly distributed circumferential external positioning ribs to form water outflow by eccentrically swaying the nozzle ball head not only saves the trouble of configuring a wear-resistant sealing ring at the nozzle ball head, thereby better simplifying the assembly structure at the location, but also prevents the nozzle ball head from being accidentally stuck by the wear-resistant sealing ring. In addition, a double-layer wear-resistant washer may be arranged between blades of the water wheel and the adjacent fixing ring to prevent wear. Compared with a conventional single wear-resistant washer, the double-layer wear-resistant washer does not directly stick to the water wheel and affect rotation. Therefore, the above structural improvements can better improve usage reliability of the washing nozzle and extend a service life.

### BRIEF DESCRIPTION OF THE DRAWINGS

FIG. 1 is a schematic diagram of a sectional structure of the present invention (a nozzle ball head is not in a circumferential eccentric swaying state).

FIG. 2 is a schematic diagram of a sectional structure of the present invention (the nozzle ball head is in a circumferential eccentric swaying state).

FIG. 3 is an outline drawing of FIG. 1.

FIG. 4 is a right view of FIG. 3.

FIG. 5 is a three-dimensional exploded view of FIG. 3.

FIG. 6 is a cross-sectional view of a housing.

### DETAILED DESCRIPTION

Embodiments of the present invention are described in detail below with reference to the above accompanying drawings.

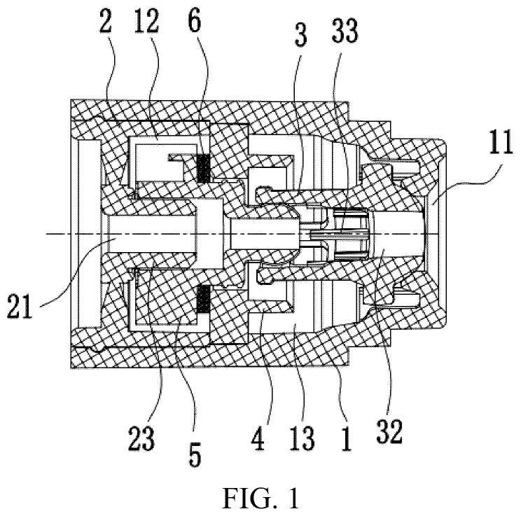

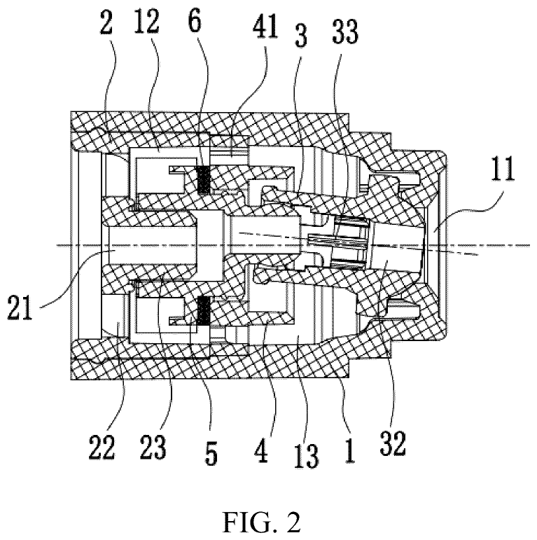

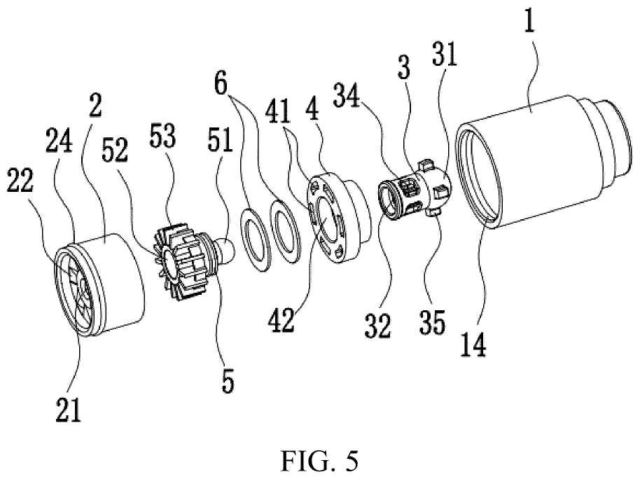

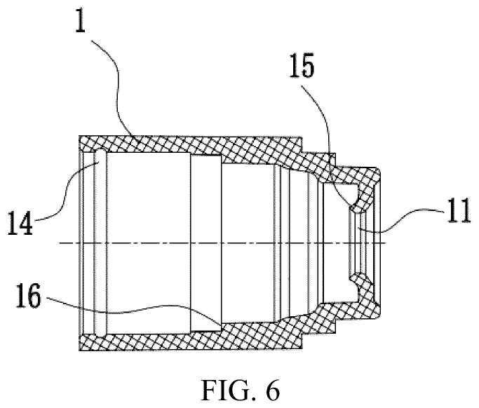

As shown in FIG. 1 to FIGS. 6, 1. Housing, 11. Jet hole, 12. Rear water chamber, 13. Front water chamber, 14. Ring groove, 15. Curling edge, 16. Inner shoulder, 2. Fixing cover, 21. Pressure relief hole, 22. Inclined water inflow hole, 23. Core shaft, 24. Convex rib, 3. Nozzle, 31. Nozzle ball head, 32. Nozzle hole, 33. Inner positioning rib, 34. Side water inflow hole, 35. External positioning rib, 4. Fixing ring, 41. Inclined water outflow hole, 42. Center hole, 5. Water wheel, 51. Water wheel ball head, 52. Water wheel hole, 53. Blade, 6. Double-layer wear-resistant washer.

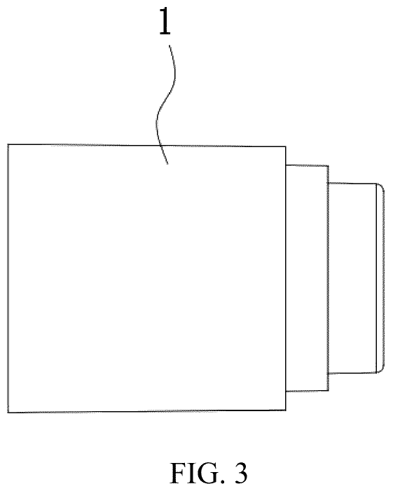

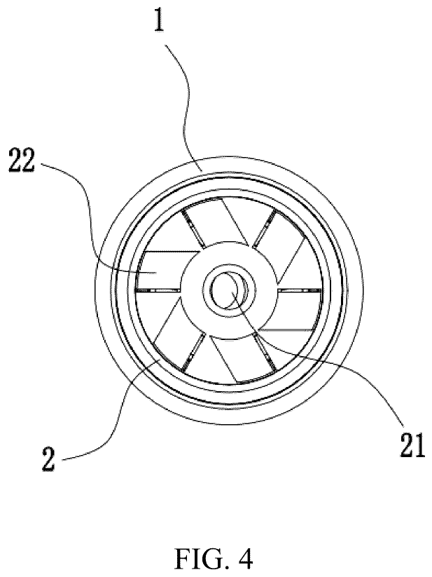

An eccentric swaying washing nozzle, as shown in FIG. 1 to FIG. 6, is mainly applied to a water gun as a terminal water outflow component. A structure thereof includes a housing 1, a jet hole 11 at a front end of the housing, and a nozzle 3, a fixing ring 4, a water wheel 5, a fixing cover 2, and the like that are successively mounted from back to front in the housing. Based on mounting positions of the above components, in this embodiment, a right side of a view shown in FIG. 1, FIG. 3, FIG. 4 is used as a front part or a front side of the washing nozzle, and a left side of the view is used as a rear part or a rear side of the washing nozzle.

The fixing cover 2 is embedded in the ring groove 14 on an inner circumferential surface of the housing 1 through a convex rib 24 on an outer circumferential surface to form mounting and fixation. A front part of the fixing ring 4 abuts against an inner shoulder 16 of the housing 1, and a rear part of the fixing ring 4 is pushed against a front part of the fixing cover 2, so that the fixing ring 4 is also mounted and fixed to the housing 1.

A core shaft 23 extending forward along an axis and a rear water chamber 12 arranged outside the core shaft are arranged on a front end surface of the fixing cover 2. A pressure relief hole 21 extending through the fixing cover 2 along the axis is provided in the fixing cover. Specifically, the pressure relief hole 21 is provided in the core shaft 23 and extends through along the axis. A plurality of evenly distributed circumferential inclined water inflow holes 22 with the pressure relief hole 21 as a center are further provided on the fixing cover 2. The plurality of inclined water inflow holes are inclined along the clockwise or counterclockwise direction and are in communication with the rear water chamber 12.

A water wheel ball head 51 is arranged at a front end of the water wheel 5. An axis of the water wheel ball head is eccentric with respect to a rotation axis of the water wheel 5, and a water wheel hole 52 extending through the water wheel 5 along the axis is provided in the water wheel. A front end of the water wheel hole extends through the water wheel ball head 51. The water wheel 5 is rotatably mounted in the housing 1. Specifically, the water wheel 5 is rotatably sleeved on the core shaft 23 through a rear end of the water wheel hole 52 to form a rotation support. A plurality of evenly distributed circumferential blades 53 in a radial pattern are arranged on the outer circumferential surface of the water wheel 5. In other words, the plurality of blades 53 of the water wheel 5 are just arranged in the rear water chamber 12. In this way, when water entering the housing 1 enters the rear water chamber 12 through the plurality of inclined water inflow holes 22, spiral water inflow may be formed through the plurality of inclined water inflow holes 22, thereby better impacting and driving the water wheel 5 to rotate.

A double-layer wear-resistant washer 6 is arranged between the plurality of blades 53 and a rear end surface of the fixing ring 4, which may be configured to separate direct contact between the water wheel 5 and the fixing ring 4 and help the water wheel 5 rotate more quickly and flexibly. In particular, compared with a conventional single wear-resistant washer, the double-layer wear-resistant washer 6 does not directly stick to the water wheel 5 and affect the rotation, thereby ensuring normal use of the washing nozzle.

A front part of the fixing ring 4 forms a front water chamber 13, and a plurality of evenly distributed circumferential inclined water outflow holes 41 with an axis of the fixing ring as a center are provided on the fixing ring 4. The plurality of inclined water outflow holes are inclined along the clockwise or counterclockwise direction. Each of the inclined water outflow holes 41 is in communication with the rear water chamber 12 and the front water chamber 13. Therefore, water inflow through rotation by impacting the water wheel 5 can also form spiral water outflow in the front water chamber 13 through the plurality of inclined water outflow holes 41. In other words, counterclockwise vortex-shaped water outflow can be formed. Such vortex-shaped water outflow may further assist the circumferential eccentric rotation of the nozzle 3.

A nozzle ball head 31 is arranged at a front end of the nozzle 3. A plurality of evenly distributed circumferential external positioning ribs 35 are arranged on an outer circumferential surface of the nozzle ball head. Each external positioning rib is a rectangular bump extending along an axial direction of the nozzle 3. A nozzle hole 32 extending through the nozzle 3 along an axis is provided in the nozzle. A front end of the nozzle hole extends through the nozzle ball head 31 and is in communication with the jet hole 11 to form water outflow. A plurality of evenly distributed circumferential side water inflow holes 34 are provided on an outer circumferential surface of the nozzle 3. Each side water inflow hole is in communication with the front water chamber 13 and the nozzle hole 32. Therefore, the inclined water inflow hole 22, the rear water chamber 12, the inclined water outflow hole 41, the front water chamber 13, the side water inflow hole 34, the nozzle hole 32, and the jet hole 11 are connected in sequence, so that a complete water inflow and outflow path can be formed in the washing nozzle.

The water wheel ball head 51 passes through a center hole 42 at the axis of the fixing ring 4 and is movably fitted in a rear end of the nozzle hole 32. A plurality of inner positioning ribs 33 are further arranged on a hole wall of the nozzle hole 32. Each inner positioning rib extends along the axial direction of the nozzle. When the water wheel ball head 51 is movably fitted in the rear end of the nozzle hole 32, the water wheel ball head just comes into contact with rear ends of the plurality of inner positioning ribs 33 to realize positioning.

In this way, when water entering the housing 1 enters the rear water chamber 12 through the inclined water inflow hole 22 and drives the water wheel 5 to rotate, the water wheel ball head 51 is first driven to perform circumferential eccentric rotation in the rear end of the nozzle hole 32, then the nozzle ball head 31 is driven through the circumferential eccentric rotation to synchronously perform circumferential eccentric swaying relative to the jet hole 11 under the restriction of the plurality of external positioning ribs 35, and finally the water outflow formed by the nozzle hole 32 extending through the jet hole 11 is also spraying in a circumferential eccentric swaying manner.

A curling edge 15 that is turned up from a hole edge of the jet hole to a rear circumference is arranged in the jet hole 11, and the nozzle ball head 31 is attached to an inner edge of the curling edge 15 through a spherical surface to perform circumferential eccentric swaying. When the nozzle ball head 31 performs circumferential eccentric swaying relative to the jet hole 11, the plurality of external positioning ribs 35 are driven to contact the curling edge 15 to form a circumferential eccentric swaying stroke of the nozzle ball head 31.

Obviously, such a manner of using the plurality of evenly distributed circumferential external positioning ribs 35 to form water outflow by eccentrically swaying the nozzle ball head 31 not only saves the trouble of configuring a wear-resistant sealing ring at the nozzle ball head, thereby better simplifying the assembly structure at the location, but also prevents the nozzle ball head from being accidentally stuck by the wear-resistant sealing ring.

In addition, when high-pressure water enters the housing 1, a pressure of the high-pressure water may be relieved by the pressure relief hole 21, the water wheel hole 52, the nozzle hole 32, and the jet hole 11 that are in communication with each other in sequence, so that the entire pressure relief process is more timely and stable, thereby effectively avoiding a situation where the water wheel 5 is stuck, which greatly improves usage reliability of the washing nozzle and extends a service life.

The above descriptions are only specific embodiments of the present invention. A person skilled in the art should understand that any structural design equivalent to this embodiment shall fall within the protection scope of the present invention.

1. An eccentric swaying washing nozzle, comprising a housing (1) and a jet hole (11) at a front end of the housing, wherein a nozzle (3), a fixing ring (4), a water wheel (5), and a fixing cover (2) that are successively mounted from back to front are arranged in the housing (1), the fixing ring (4) and the fixing cover (2) are both fixed in the housing (1), the water wheel (5) is rotatably mounted in the housing (1), a nozzle ball head (31) is arranged at a front end of the nozzle (3), a plurality of evenly distributed circumferential external positioning ribs (35) are arranged on an outer circumferential surface of the nozzle ball head, a nozzle hole (32) extending through the nozzle (3) along an axis is provided in the nozzle, a front end of the nozzle hole extends through the nozzle ball head (31) and is in communication with the jet hole (11) to form water outflow, water entering the housing (1) drives the water wheel (5) to rotate and drives a rear end of the nozzle (3) to perform circumferential eccentric rotation, and then drives the nozzle ball head (31) to synchronously perform circumferential eccentric swaying relative to the jet hole (11) under the restriction of the plurality of external positioning ribs (35), and the water outflow formed by the nozzle hole (32) in communication with the jet hole (11) is also spraying in a circumferential eccentric swaying manner.

2. The eccentric swaying washing nozzle according to claim 1, wherein each of the external positioning ribs (35) is a rectangular bump extending along an axial direction of the nozzle (3).

3. The eccentric swaying washing nozzle according to claim 1, wherein a curling edge (15) that is turned up from a hole edge of the jet hole to a rear circumference is arranged in the jet hole (11), and the nozzle ball head (31) is attached to an inner edge of the curling edge (15) through a spherical surface to perform circumferential eccentric swaying.

4. The eccentric swaying washing nozzle according to claim 3, wherein the nozzle ball head (31) performs a circumferential eccentric swaying relative to the jet hole (11), and drives the plurality of external positioning ribs (35) to contact the curling edge (15) to form a circumferential eccentric swaying stroke of the nozzle ball head (31).

5. The eccentric swaying washing nozzle according to claim 1, wherein a plurality of evenly distributed circumferential blades (53) in a radial pattern are arranged on an outer circumferential surface of the water wheel (5), and a double-layer wear-resistant washer (6) is arranged between front end surfaces of the plurality of blades and a rear end surface of the fixing ring (4).

6. The eccentric swaying washing nozzle according to claim 1, wherein a water wheel ball head (51) is arranged on a front end of the water wheel (5), an axis of the water wheel ball head is eccentric with respect to a rotation axis of the water wheel (5), the water wheel ball head (51) passes through a center hole (42) of the fixing ring (4) and is movably fitted in a rear end of the nozzle hole (32), and the water wheel (5) rotates to drive the water wheel ball head (51) to perform circumferential eccentric rotation in the rear end of the nozzle hole (32), thereby driving the rear end of the nozzle (3) to synchronously perform the circumferential eccentric rotation.

7. The eccentric swaying washing nozzle according to claim 6, wherein a pressure relief hole (21) extending through the fixing cover (2) along the axis is provided in the fixing cover, a water wheel hole (52) extending through the water wheel (5) along the axis is provided in the water wheel, a front end of the water wheel hole extends through the water wheel ball head (51), high-pressure water enters the housing (1), and a pressure of the high-pressure water is relieved by the pressure relief hole (21), the water wheel hole (52), the nozzle hole (32), and the jet hole (11) that are in communication with each other in sequence.

8. The eccentric swaying washing nozzle according to claim 7, wherein a core shaft (23) extending forward along the axis is arranged on a front end surface of the fixing cover (2), the water wheel (5) is rotatably sleeved on the core shaft (23) through a rear end of the water wheel hole (52), and the pressure relief hole (21) is provided in the core shaft (23) and runs through along the axis.

9. The eccentric swaying washing nozzle according to claim 7, wherein a rear water chamber (12) is provided on a front end surface of the fixing cover (2), a plurality of evenly distributed circumferential inclined water inflow holes (22) with the pressure relief hole (21) as a center are provided on the fixing cover (2), the plurality of inclined water inflow holes are inclined along a clockwise or counterclockwise direction and in communication with the rear water chamber (12), the plurality of blades (53) of the water wheel (5) are arranged in the rear water chamber (12), and the water entering the housing (1) enters the rear water chamber (12) through the plurality of inclined water inflow holes (22) and impacts the plurality of blades (53) to drive the water wheel (5) to rotate.

10. The eccentric swaying washing nozzle according to claim 7, wherein a front part of the fixing ring (4) forms a front water chamber (13), a plurality of evenly distributed circumferential inclined water outflow holes (41) with an axis of the fixing ring as a center are provided on the fixing ring (4), the plurality of inclined water outflow holes are inclined along the clockwise or counterclockwise direction, each of the inclined water outflow holes (41) is in communication with the rear water chamber (12) and the front water chamber (13), a plurality of evenly distributed circumferential side water inflow holes (34) are provided on an outer circumferential surface of the nozzle (3), and each of the side water inflow holes is in communication with the front water chamber (13) and the nozzle hole (32).
